(19) United States
(12) Patent Application Publication
(10) Pub. No.: US 2016/0230902 A1
(43) Pub. Date: Aug. 11, 2016

(54) Valve

(71) Applicant: FESTO AG & CO. KG, Esslingen (DE)

(72) Inventors: Jasmin HOTZ, Lichtenwald (DE); Andre GELBMANN, Neidlingen (DE); Michael KANTHACK, Wimsheim (DE)

(21) Appl. No.: 15/022,791

(22) PCT Filed: Feb. 6, 2015
(86) PCT No.: PCT/EP2015/000243

§ 371 Date: Mar. 17, 2016

(30) Foreign Application Priority Data
Mar. 31, 2014 (DE) 10 2014 004 670.2

(51) Int. Cl. F16K 27/02; F16K 1/10; F16K 7/14; F16K 31/122

(52) U.S. Cl. CPC F16K 27/02; F16K 31/1221; F16K 1/10; F16K 7/14

(57) ABSTRACT

A valve with a valve housing through which process medium may flow and in which is located a valve seat encompassing a through-flow orifice and assigned a valve member mounted on a spindle in such a way that the valve member is movable by means of a stroke of the spindle between a blocking position in which the valve member fits up with process-medium-tight sealing against the valve seat, and an open position in which the valve member is lifted from the valve seat, wherein there is accommodated in the valve housing a sealing device through which the spindle passes and which seals the spindle passage, and with a valve drive which has a drive housing and an operating wall arranged movably in the drive housing, which may be subjected to fluid pressure and generates the stroke of the spindle.

The invention relates to a valve with a valve housing through which process medium may flow and in which is located a valve seat encompassing a through-flow orifice and assigned a valve member mounted on a spindle in such a way that the valve member is movable by means of a stroke of the spindle between a blocking position in which the valve member fits up with process-medium-tight sealing against the valve seat, and an open position in which the valve member is lifted from the valve seat, wherein there is accommodated in the valve housing a sealing device through which the spindle passes and which seals the spindle passage, and with a valve drive which has a drive housing and an operating wall arranged movably in the drive housing, which may be subjected to fluid pressure and generates the stroke of the spindle, and wherein there are provided on the valve housing a valve housing interface and on the drive housing a drive housing interface for the connection of valve housing and drive housing.

A valve of this type is described for example in EP 0 897 076 B1. The valve disclosed there is designed as a membrane valve and has a valve member in the form of a membrane, which is connected to the spindle via a pressure piece. The spindle in turn is connected to a drive member in the form of a piston. The piston is guided movably in a drive housing. The drive housing has for this purpose a housing top section screwed on to an intermediate piece which is part of the valve housing. The spindle passes through the intermediate piece and is in turn fixed by screws to a base part of the valve housing. The membrane is clamped between the intermediate piece and the base part of the valve housing. The piston chamber of the piston, which may be acted upon by pressure, is therefore bounded by the inner wall of the intermediate piece and the inner wall of the housing top section.

In disassembly of the drive, the housing top section is unscrewed from the intermediate piece. In addition it is necessary to break the connection between the spindle and the piston. Another option is to remove the intermediate piece and housing top section together from the rest of the valve housing. This involves loosening the screws between the base part of the valve housing and the intermediate piece. However this also loosens the clamping of the membrane, so that the remaining valve housing base section is now without a membrane and consequently it is no longer possible to block the valve through-flow orifice.

The problem of the invention is to create a valve of the type referred to above, which may be assembled and/or disassembled in a simple manner and is characterised by greater functionality than valves known from the prior art.

This problem is solved by a valve with the features of the independent claim 1. Developments of the invention are described in the dependent claims.

The valve according to the invention is distinguished by the fact that the drive housing has, in front of the operating wall, a housing base bounding a working space for the operating wall, on which the drive housing interface is provided.

The valve according to the invention is divided into several functional modules, each in itself fully functional. So for example the drive housing may be loosened in a simple manner by releasing the interface connection at the interface between drive housing and valve housing. The sealing device accommodated in the valve housing ensures that the valve housing, even with the drive removed, forms a closed unit which may be used separately. In particular, this makes it possible to install the valve housing or the valve fitting without a drive in process medium lines. Without the drive, this is easier than with the drive fitted, due not only to the lower weight but also the smaller overall size. Also, it is possible to perform pressure tests on the valve housing with the drive housing removed, which means therefore that all fluid-side operating steps may be completed before the valve drive is attached. The sealing device accommodated in the valve housing therefore seals the process medium tightly, irrespective of whether or not the valve drive is connected.

In principle the valve consists of a valve housing and a valve fitting. As valve drives, it is possible to use fluidic, electrical, magnetic and manual, for example operated by means of a hand wheel, valve drives. Possible valve fittings are angle seat, straight seat or membrane valve fittings. It is therefore possible for the valve to have a valve drive component and a valve housing component, each of which may be in the form of pre-assembled modules which can be put together or separated from one another easily and quickly.

In a development of the invention, an operating rod connected to the operating wall passes through the housing base, and sealing means to seal the passage of the operating rod are accommodated in the housing base.

In an especially preferred manner the housing base has a bottom base part connected, pressure-tight, to the rest of the drive housing and with an inner wall bounding the working space, and a drive-side interface part with the drive housing interface and connected to the bottom base part.

It is possible for the drive-side interface part to be a separate component from the bottom base part, and attached to the bottom base part.

In a development of the invention, the valve housing has a valve housing base section, and a fluid-side interface part with the valve housing interface and connected to the valve housing base section. In a preferred manner, therefore, the valve housing interface is formed on the fluid-side interface part, while the corresponding drive housing interface is located on the drive-side interface part.

Preferably the fluid-side interface part is a separate component from the valve housing base section and may be attached, in particular releasably, to the valve housing. The fluid-side interface part is preferably hollow-cylindrical in form. Due to this releasable fastening to the valve housing base section, the fluid-side interface part may be replaced easily and quickly as necessary. Altogether, this creates enhanced modularity. Suitable for the releasable connection with the valve housing base section is for example a threaded connection. Alternatively it is possible for the fluid-side interface part and the valve housing base section to be made as one piece.

In a development of the invention, the sealing device is accommodated in the fluid-side interface part.

Especially suitable for this purpose is the provision of the sealing device in a sealing cartridge, separate from the valve housing, designed as a ready for use pre-assembled module and attached to the valve housing.

Valve housing, sealing cartridge and connected valve drive are therefore units made separate from one another, which may be put together or disassembled easily and quickly. This makes possible a rapid and cost-effective replacement of seals which are prone to wear.

Expediently the sealing cartridge has a cartridge housing, in which is accommodated a seal assembly including sealing means, biased by spring means against the cartridge housing and fitting up against the spindle with sealing.

In a development of the invention, the operating rod and the spindle are or may be connected to one another over a further inner interface. Expediently this further inner interface for the case where the valve housing interface and the drive housing interface are connected to one another is located in a chamber which is closed off from the environment. This prevents the ingress of dirt into the area of the inner interface,

In a development of the invention, the operating wall is in the form of an operating piston to which fluid pressure may be applied. The operating piston is expediently part of a fluidic linear drive. A membrane which may be subjected to fluid pressure is also conceivable as an alternative to an operating piston to which fluid pressure may be applied.

It is possible that the working space is in the form of a working chamber which may be subjected to fluid pressure. Alternatively, though, it would also be conceivable for the working space to be available only for the accommodation of spring means for pressurisation of the operating wall, with a further working chamber which may be subjected to fluid pressure being provided.

In an especially preferred manner the valve includes an attachment part, which may be connected at the valve housing interface with the valve housing instead of the drive housing, and in the attached state presses the spindle into its blocking position. By this means it is thus possible for the valve to be installed in a process medium line with its valve member in the blocking position.

Preferred embodiments of the invention are shown in the drawing and are explained in detail below. The drawing shows in:

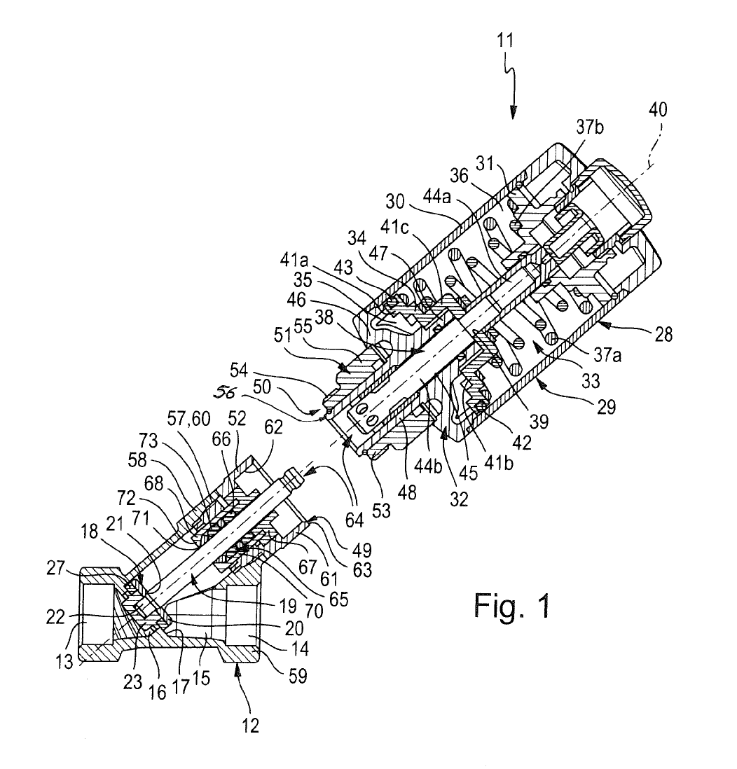

FIG. 1 a longitudinal section through a first embodiment of the valve according to the invention with the valve drive separated from the valve housing and

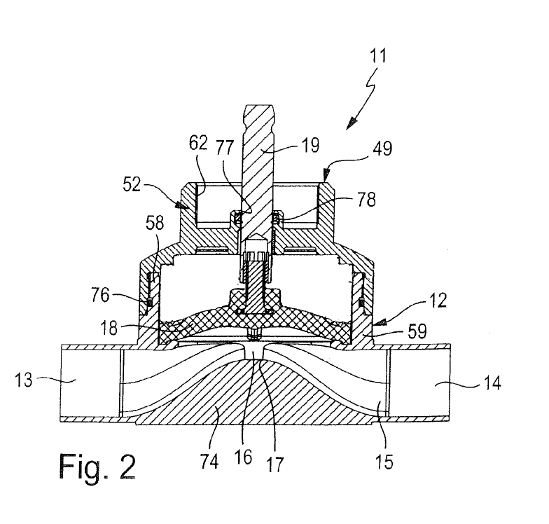

FIG. 2 a longitudinal section through a second embodiment of the valve according to the invention without valve drive.

FIG. 1 shows a first embodiment of the valve 11 according to the invention. The valve 11 is suitable for use as a process valve in the processing industry. The valve 11 according to the invention and according to the first embodiment will be explained below by way of example with the aid of a so-called angle seat valve. However the invention may also be applied to a straight seat valve.

As shown in particular in FIG. 1, the valve 11 has a valve housing 12 in which a through-flow passage 15 extends between an inlet 13 and an outlet 14.

In the case of use in the food processing industry, the valve housing 12 is made expediently of stainless steel. If aggressive substances, for example acid, are used as process media, the valve housing 12 is made expediently of plastic material, which has a greater chemical resistance to such substances.

In the through-flow passage 15, between the inlet 13 and the outlet 14, is a through-flow orifice 16 which is encompassed by an annular valve seat 17. Expediently the valve seat 17 is circular in shape. Theoretically, however, a valve seat 17 of oval shape would also be conceivable. The valve seat 17 is assigned a valve member 18, which in turn is mounted on a spindle 19.

The valve member 18 is shown purely by way of example as a multi-part component, and has in this case a plate 20 provided with a through hole, through which an end section 22 of the spindle may be inserted. The plate 20 is for example welded to the spindle 19. The valve member 18 also includes a mating piece 23 which is provided with a blind hole type locating orifice 24, which is provided with an internal thread. Complementary to the latter, there is provided at the end section 22 of the 19 an external thread, with which the mating piece 23 may be screwed on to the end section 22 of the spindle 19. Clamped between the mating piece 23 and the plate 20 is an annular seal ring 27 which is expediently made of plastic, for example PTFE.

The valve member 18 may be moved by means of a stroke of the spindle 19 between a blocking position in which the valve member 18 fits up with its seal ring 27, fluid-tight, against the valve seat 17, and an open position in which the valve member 18 is lifted from the valve seat 17. The stroke of the spindle 19 is generated by its valve drive 28.

The valve drive 28 is shown in FIG. 1 by way of example with the aid of a fluidic linear drive in the form of a pneumatic piston drive. The valve drive 28 has a drive housing 29. The drive housing 29 is a self-contained unit which can be pre-assembled, with a hollow-cylindrical housing body 30 given a fluid-tight seal by a housing cover 31 at the top and a housing base 32 at the bottom. The housing body 30 may be made of aluminium, for example as an aluminium extruded part. If necessary, the aluminium 30 may also be cladded with a stainless steel sleeve. Alternatively, however it would also be conceivable to produce the housing body 30 as a stainless steel part.

The housing cover 31, the housing base 32 and the housing body 30 define an interior 33 in which an operating wall 34 in the form of an operating piston, which may be subjected to fluid pressure, is movably guided and divides the interior 33 into two working spaces 35, 36 or working chambers. In the exemplary case, a single-acting piston drive is shown, in which one of the two working spaces 35 may be pressurised by compressed air, while in the other working space 36 at least one, in the exemplary case two, resetting springs 37a, 37b are mounted. Here the arrangement is chosen so that the resetting springs 37a, 37b press the operating piston downwards to the first working space 35, leading to pressure on the connected spindle 19 and the valve member 18 and valve seat 17 connected to it. Such a design is also described as Normally Closed. If the first working space 35 is supplied with compressed air, then the operating piston is pressed upwards against the resetting force of the resetting springs 37a, 37b, so that ultimately the valve member 18 is lifted from the valve seat 17.

The operating piston is plate-shaped and permanently connected to an operating rod 38 in the form of a piston rod, which here extends through the operating piston via a through opening 39. The operating piston is in the exemplary case divided into several annular cylinder sections 41a-c, stacked one behind the other in the axial direction of a longitudinal axis 40 running through the piston rod and the spindle 19, and differing from one another in their respective outside diameters. The first cylinder section 41a has the largest outside diameter and makes contact with its peripheral surface with the inner wall of the housing body 30. Formed in the peripheral surface of the first cylinder section 41a is an annular sealing groove 42, in which a seal ring 43, made in particular of plastic material, is held. The seal ring 43 ensures dynamic sealing between the peripheral surface of the first cylinder section 41a of the operating piston and the inner surface of the housing body 30. Supported on the end face of the first cylinder section 41a facing away from the first working space 35 is the first resetting spring 37a, which rests at the other end on the housing cover 31.

Adjoining the first cylinder section 41a of the operating piston is a second cylinder section 41b, which has a smaller outside diameter. Resting on the end face which there faces away from the working space 35 is the second resetting spring 37b, which at the other end also rests on the housing cover 31. Finally, adjoining the second cylinder section 41b in the axial direction is a third cylinder section 41c, in which the through opening of the piston rod is formed.

The piston rod extends with a first piston rod section 44a into the second working space 36, while a second piston rod section 44b passes through the first working space 35 and is guided out of the drive housing 29 via a cylindrical through passage 45 formed in the housing base 32. The housing base 32 has a bottom base part 46 which has a fluid-tight connection with the housing body 30 and for example is welded to the latter. Adjoining the bottom base part 46 of the housing base 32 on this side is a first extension 47 which extends into the first working space 35, while on the other side of the bottom base part 46 a second cylindrical extension 48 is formed, extending downwards from the drive housing 29. Provided on the valve housing 12 is a valve housing interface 49, while on the drive housing 29 a drive housing interface 50 is provided for connection of the valve housing 12 and the drive housing 29.

The drive housing interface 50 is provided on a drive-side interface part 51, which is made as a separate component to the rest of the drive housing 29. The drive-side interface part 51 is sleeve-shaped and is fitted on to the second cylindrical first extension 48 of the housing base 32, where it is rotatably connected to the second cylindrical extension 48, in particular by means of a spring ring connection. The drive-side interface part 51 is brought into engagement with a fluid-side interface part 52. For this purpose the drive-side interface part 51 has a hollow-cylindrical mounting section 53, on the peripheral surface of which is formed an external thread 54. Alternatively it is possible to form an internal thread on the mounting section 53. Adjoining the mounting section 53 in the axial direction is a base section 55 of greater diameter.

The fluid-side interface part 52 is hollow-cylindrical in form and has several functional sections. One of these functional sections is a cylindrical fixing section, on the peripheral surface of which an external thread 57 is formed. Corresponding to this external thread 57 is an internal thread 60 formed on a locating nozzle 58 of the valve housing 12, by means of which the interface part 52 may be screwed into the valve housing 12. The locating nozzle 58 is a one-piece component of a valve housing base section 59. The fluid-side interface part 52 may, because of the screw connection described above, be removed easily from the valve housing base section 59. In the case of smaller nominal widths it is possible for the interface part 52 and the valve housing 12 to be made as a one-piece component, made for example from cast material.

The fluid-side interface part 52 also has a mounting area 61 assigned to the mounting section 53 on the drive-side interface part 51, with an internal thread 62 formed on its inner wall. As an alternative it would be possible to form an external thread on the mounting area. The end face of the mounting area 61 forms a mating stop face 63, which is assigned to the stop face 56 on the drive-side interface part 51.

The drive-side interface part 51 and with it the whole drive housing 29 may therefore be screwed into the fluid-side interface part 52, by which means the drive housing 29 and the valve housing 12 are connected to one another.

On screwing-in the drive-side interface part 51 an end position is reached which is defined by the stop of the stop face 56 and the mating stop face 63 which correspond with one another.

Also provided is a further inner interface 64, which serves to connect the spindle to the piston rod.

Also belonging to the valve 11 is a sealing device 65 through which the spindle 19 reaches and which has a seal assembly 66 comprising sealing means, biased by spring means and fitting up with sealing against the spindle 19. The sealing device 65 is accommodated in a sealing cartridge 67, in the form of a ready for use pre-assembled module which is separate from the valve housing 12. The sealing cartridge has a cartridge housing 68 which is or may be fastened to the valve housing 12 and in which the spring means for biasing the seal assembly are accommodated.

The cartridge housing 68 has several functional sections, including a locating section 69 for holding the seal assembly 66 and the spring means. The locating section 69 is cup-shaped and has an envelope area 70 which envelops the seal assembly 66 and the spring means, and a bottom area 72 provided with a central through hole 71.

The seal assembly is shown by way of example in the form of a V-sleeve, wherein several annular V-sleeves 73 stacked one above the other in the axial direction are provided as single sealing elements.

FIG. 2 shows a second embodiment of the valve 11 according to the invention. In contrast to the first embodiment described above, the valve 11 of the second embodiment is altogether designed as a membrane valve. Here too is provided a valve housing 12, which has an inlet 13 and an outlet 14 and a through-flow passage 15 connecting the inlet 13 and the outlet 14 to one another. Also provided is a through-flow orifice 16 which is strongly tapered compared to the rest of the diameter of the through-flow passage 15. The through-flow orifice 16 is bounded at one end by an elevation 74, on which is provided a valve seat 17 for the valve member 18. The valve member 18 is in the form of a membrane, which is connected to the spindle 19 via connection means. As FIG. 2 shows, the locating nozzle 58 has an external thread, which may be screwed together with the fluid-side interface part 52 and an internal thread 62 provided there. An annular seal 76 is also inserted between the external thread on the locating nozzle 58 and the internal thread of the fluid-side interface part 52.

A through opening 77, through which the spindle 19 is guided, passes through the fluid-side interface part 52. The spindle passage is sealed by an annular seal 78.

This membrane valve is also, therefore, like the angle seat valve described in the first embodiment, sealed fluid-tight with the drive disconnected. The membrane valve maybe installed in a process medium line in the state shown in FIG. 2, i.e. it may be fitted without the drive.

1. A valve with a valve housing through which process medium may flow and in which is located a valve seat encompassing a through-flow orifice and assigned a valve member mounted on a spindle in such a way that the valve member is movable by means of a stroke of the spindle between a blocking position in which the valve member fits up with process-medium-tight sealing against the valve seat, and an open position in which the valve member is lifted from the valve seat, wherein there is accommodated in the valve housing a sealing device through which the spindle passes and which seals the spindle passage, and with a valve drive which has a drive housing and an operating wall arranged movably in the drive housing, which may be subjected to fluid pressure and generates the stroke of the spindle, and wherein there are provided on the valve housing a valve housing interface and on the drive housing a drive housing interface for the connection of valve housing and drive housing, and wherein the drive housing has, in front of the operating wall, a housing base bounding a working space for the operating wall, on which the drive housing interface is provided.

2. A valve according to claim 1, wherein an operating rod connected to the operating wall passes through the housing base, and sealing means to seal the operating rod are accommodated in the housing base.

3. A valve according to claim 1, wherein the housing base has a bottom base part connected, pressure-tight, to the rest of the drive housing and with an inner wall bounding the working space, and a drive-side interface part having the drive housing interface and connected to the bottom base part.

4. A valve according to claim 3, wherein the drive-side interface part is designed as a separate component from the bottom base part, and is attached to the bottom base part.

5. A valve according to claim 1, wherein the valve housing has a valve housing base section, and a fluid-side interface part having the valve housing interface and connected to the valve housing base section.

6. A valve according to claim 5, wherein the fluid-side interface part is designed as a separate component from the valve housing base section.

7. A valve according to claim 5, wherein the sealing device is accommodated in the fluid-side interface part.

8. A valve according to claim 1, wherein the sealing device is accommodated in a sealing cartridge, separate from the valve housing, designed as a ready for use pre-assembled module and attached to the valve housing.

9. A valve according to claim 8, wherein the sealing cartridge has a cartridge housing, in which is accommodated a seal assembly including sealing means, biased by spring means against the cartridge housing and fitting up against the spindle with sealing.

10. A valve according to claim 1, wherein the operating rod and the spindle are or may be connected to one another over a further inner interface.

11. A valve according to claim 1, wherein the operating wall is in the form of an operating piston to which fluid pressure may be applied.

12. A valve according to claim 1, wherein the working space is in the form of a working chamber which may be subjected to fluid pressure.

13. A valve according to claim 1, further comprising an attachment part, which may be connected at the valve housing interface with the valve housing instead of the drive housing, and in the attached state presses the valve member into its blocking position.
